(19) United States
(12) Patent Application Publication
(10) Pub. No.: US 2005/0188779 A1
(43) Pub. Date: Sep. 1, 2005

(54) Short shift assembly

(76) Inventor: Jeffrey Lowell, Ventura, CA (US)

Correspondence Address: CHRISTIE, PARKER & HALE, LLP, PO BOX 7068, PASADENA, CA, 91109-7068, US

(21) Appl. No.: 10/645,455

(22) Filed: Aug. 21, 2003

Related U.S. Application Data
(60) Provisional application No. 60/405,945, filed on Aug. 26, 2002.

(51) Int. Cl. G05G 9/00

(52) U.S. Cl. 74/473.34

(57) ABSTRACT

A shift lever assembly is provided that includes a shift lever having a fulcrum. A shift lever arm is attached to the shift lever. The shift lever arm has a first cable attachment site disposed at a first radial distance from the fulcrum. A short throw assembly is attached to one of the shift lever and the shift lever arm. The short throw assembly has a second cable attachment site disposed at a second radial distance from the fulcrum, such that second radial distance is greater than the first radial distance.

### CROSS-REFERENCE TO RELATED APPLICATION(S)

This application claims priority under 35 U.S.C. §119(e) to U.S. Provisional Application Ser. No. 60/405,945, filed on Aug. 26, 2002, the disclosure of which is incorporated by reference.

### FIELD OF THE INVENTION

The present invention relates generally to an apparatus for reducing a throw of an automobile shift lever assembly.

### BACKGROUND OF THE INVENTION

Many automobiles have shift levers that enable a driver of an automobile to manually shift an automobile transmission from one gear to another gear (commonly referred to as shifting gears). An amount of movement that the driver must impart on the shift lever in order to shift gears is called a shift lever throw. When the driver moves the shift lever by the required shift lever throw, a cable that is attached to both the shift lever and a gear shifting mechanism causes the automobile transmission to shift from one gear to another gear. Recently, attempts have been made to reduce the shift lever throw while maintaining the cable movement required to shift gears.

For example, the shift lever throw can be reduced by reducing the length of the shift lever. However, this often makes the shift lever more difficult to maneuver, less accessible to the driver and/or less ergonomic for the driver. Accordingly, a need exists for an improved apparatus for reducing an automobile shift lever throw.

### SUMMARY

In one embodiment, the present invention is a shift lever assembly is that includes a shift lever having a fulcrum. A shift lever arm is attached to the shift lever. The shift lever arm has a first cable attachment site disposed at a first radial distance from the fulcrum. A short throw assembly is attached to one of the shift lever and the shift lever arm. The short throw assembly has a second cable attachment site disposed at a second radial distance from the fulcrum, such that second radial distance is greater than the first radial distance. The short throw assembly also includes an inner surface that is complementary with an outer surface of the shift lever arm.

In another embodiment, the present invention is a shift lever assembly that includes a shift lever having a fulcrum. The shift lever arm is attached to the shift lever. The shift lever arm has a first cable attachment site disposed at a first radial distance from the fulcrum. A short throw assembly is attached to one of the shift lever and the shift lever arm. The short throw assembly has a second cable attachment site disposed at a second radial distance from the fulcrum, wherein the second radial distance is in the range of approximately 0.1 inch to approximately 1.0 inch greater than the first radial distance. The short throw assembly also includes a first portion and a second portion, wherein the first portion is secured to the second portion by at least one fastener, and an inner surface that is complementary with an outer surface of the shift lever arm.

In yet another embodiment, the present invention is a short throw assembly for reducing the throw on a 2002 Honda Civic shift lever assembly, wherein the 2002 Honda Civic shift lever assembly includes a shift lever having a fulcrum and a shift lever arm attached to the shift lever. The shift lever arm has a first cable attachment site disposed at a first radial distance from the fulcrum. The short throw assembly includes a second cable attachment site disposed at a second radial distance from the fulcrum, wherein the second radial distance is greater than the first radial distance. The short throw assembly also includes an inner surface that is complementary with an outer surface of the shift lever arm.

### BRIEF DESCRIPTION OF THE DRAWINGS

Novel features and advantages of the present invention will be better understood by reference to the following detailed description when considered in conjunction with the accompanying drawings wherein:

FIG. 1 is an exploded perspective view of a short shift assembly according to one exemplary embodiment of the present invention;

FIG. 2 is an assembled perspective view of the short shift assembly of FIG. 1 having a connection to a gear shift mechanism shown schematically;

FIG. 3 is a perspective view of the short shift assembly of FIG. 2 showing the movement of the short shift assembly during a shift lever throw, from a first position (shown in dashed lines) to a second position (showed in solid lines) and a schematic representation of a connection of the short shift assembly to the gear shift mechanism;

FIG. 4 is a schematic representation of the movement of the short shift assembly during a shift lever throw, from a first position (shown in dashed lines) to a second position (showed in solid lines);

FIG. 5 is an assembled perspective view of a short shift assembly according to an exemplary alternative embodiment of the present invention, having a connection to a gear shift mechanism shown schematically; and

FIG. 6 is an assembled perspective view of a short shift assembly according to another exemplary alternative embodiment of the present invention, having a connection to a gear shift mechanism shown schematically.

### DETAILED DESCRIPTION OF THE INVENTION

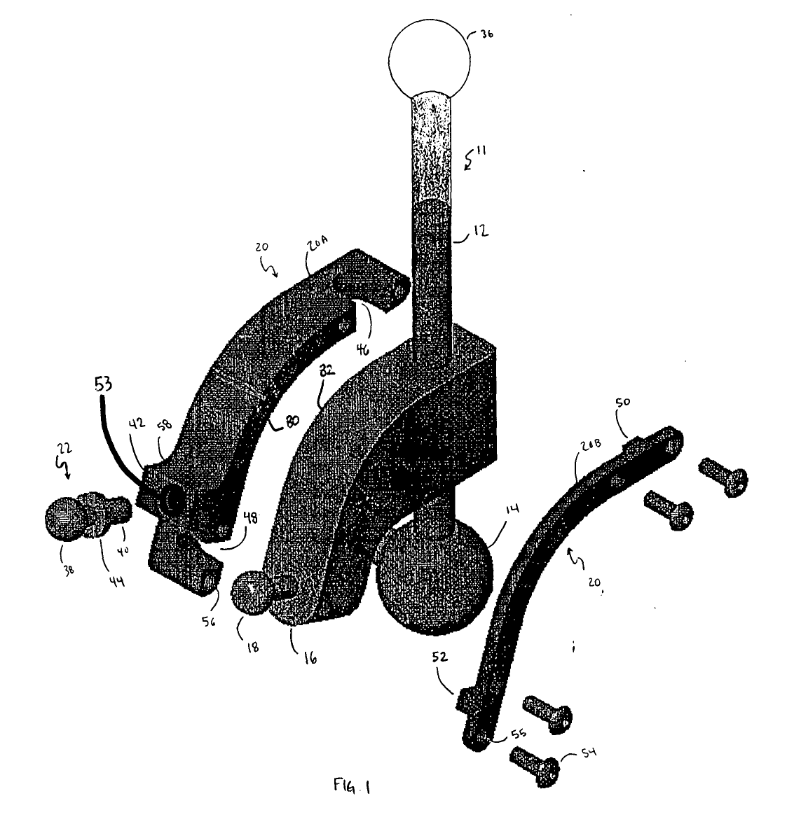

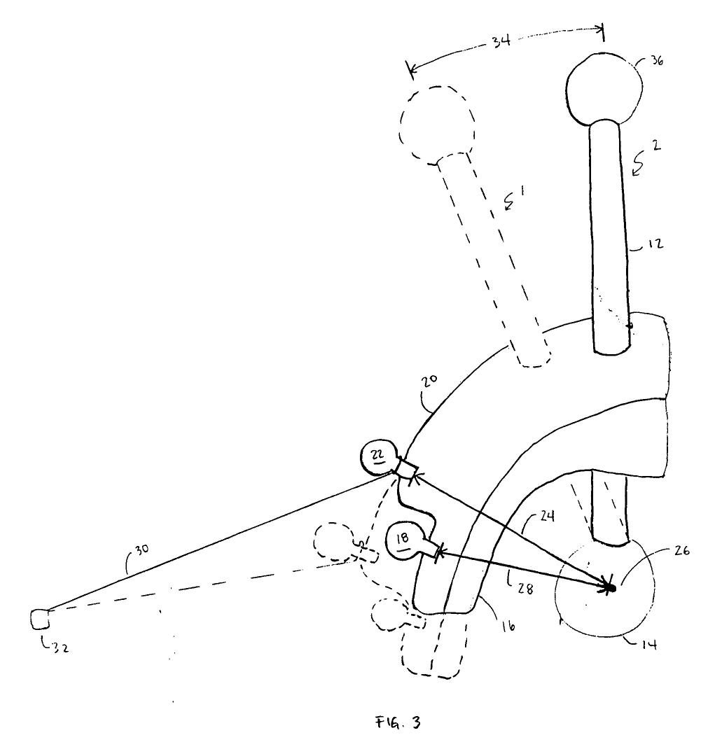

As shown in FIGS. 1-6, the present invention is directed to a short throw assembly 20,20′,20″ for an automobile that can be easily retrofitted to an existing shift lever assembly to shorten a throw of the shift lever assembly and to a shift lever assembly fitted with such a short throw assembly. For example, some vehicles, such as a 2002 Honda Civic, include a shift lever assembly 11 that has a shift lever 12 connected to a ball joint 14 and a shift lever arm 16 connected to the shift lever 12, as shown in FIG. 1. The shift lever 12 may be integrally formed with the ball joint. Similarly, the shift lever 12 may be integrally formed with the shift lever arm 16. An original cable attachment pin 18 is attached to the shift lever arm 16. To shorten a shift lever throw 34 (FIG. 3) of the shift lever assembly 11, the short throw assembly 20 is coupled to the shift lever assembly 11 (FIGS. 1-3).

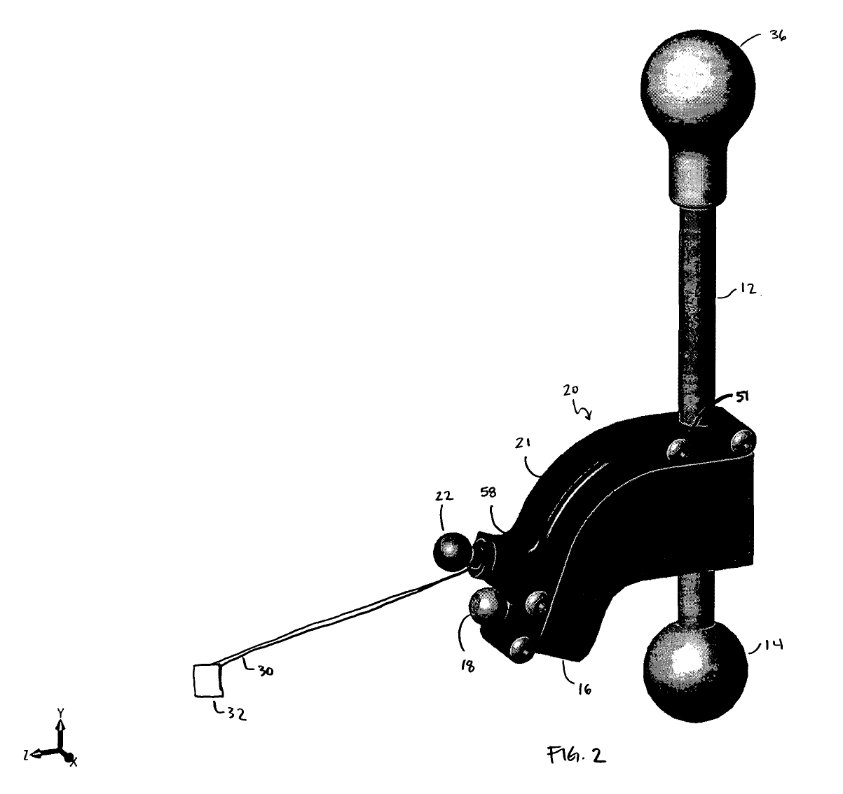

The short throw assembly 20 includes a cable attachment pin 22. A cable 30, as shown schematically in FIGS. 2 and 3, is attached at one end to the cable attachment pin 22 and at an opposite end to a gear shift mechanism 32, such that when the cable 30 is moved an appropriate distance, the cable 30 causes the automobile transmission to shift from one gear to another gear. The shift lever throw 34 is an amount of movement that the shift lever 12 must be moved in order to move the cable 30 by the appropriate distance necessary to shift gears.

The cable attachment pin 22 of the short throw assembly 20 is positioned, such that a distance 24 between a fulcrum 26 of the shift lever 12 and the cable attachment pin 22 is greater than a distance 28 between the shift lever fulcrum 26 and the original cable attachment pin 18 (FIG. 3). Thus, for any given shift lever throw 34, a cable attached to the cable attachment pin 22 will travel along a longer arc than a cable attached to the original cable attachment pin 18. As a result, the shift lever throw 34 required to move a cable attached to the cable attachment pin 22 by the appropriate distance necessary to actuate the gear shift mechanism 32 to shift the gears is less than the shift lever throw 34 required to move a cable attached to the original cable attachment pin 18 by the appropriate distance necessary to actuate the gear shift mechanism 32 to shift the gears.

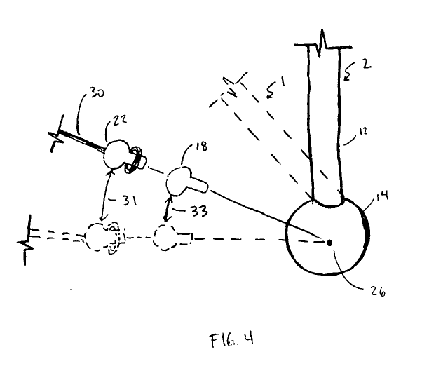

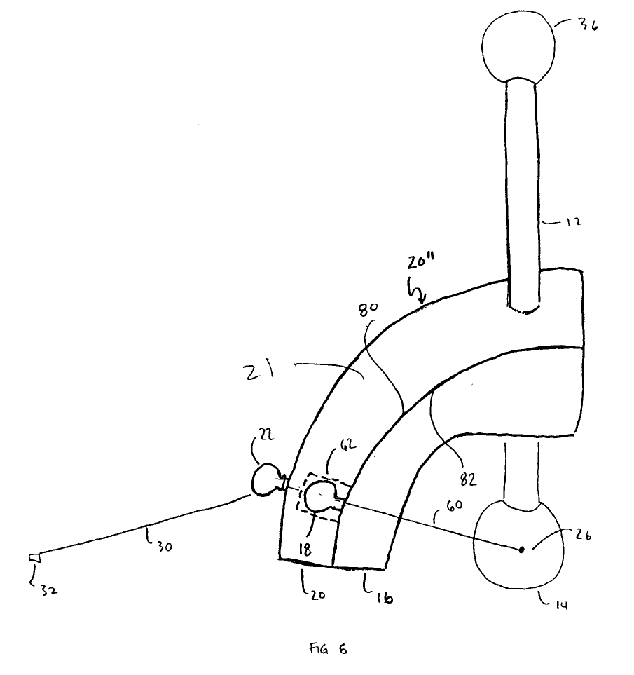

FIG. 4 is a schematic representation of the principle upon which the present invention is based. FIG. 4 shows the shift lever 12 as it is moved from a first position 1 (shown in dashed lines) to a second position 2 (shown in solid lines). The movement of the shift lever 12 causes a corresponding movement of the cable attachment pin 22 and the original cable attachment pin 18. As illustrated, as the shift lever 12 moves from the first position 1 to the second position 2, the distance 31 traveled by the cable attachment pin 22 is greater than the distance 33 traveled by the original cable attachment pin 18. Thus, the distance traveled by a cable attached to the cable attachment pin 22 is also greater than the distance traveled by a cable attached to the original cable attachment pin 18 during a shift lever throw 34. This is true when the cable attachment pin 22 is in line with a straight line from the shift lever fulcrum 26 to the original cable attachment pin 18, (as is shown in FIGS. 4 and 6) as well as when the cable attachment pin 22 is off-set from a straight line from the shift lever fulcrum 26 to the original cable attachment pin 18 (as is shown in FIGS. 1, 2, 3 and 5).

The shift lever 12 may also be attached at its end to a handle 36 for manipulated by a driver of the automobile. The handle 36 may be ergonomically designed for comfort and ease of manipulation by the automobile driver. The shift lever 12 and the shift lever arm 16 may each be formed from or include any one of a variety of materials, such as a plastic polymer, a thermoplastic material or a metal material. For example, in one embodiment, the shift lever 12 is composed of a metal material, and the shift lever arm 16 is composed of a plastic polymer. However, in other embodiments, the shift lever 12 and the shift lever arm 16 may be composed of the same or similar materials.

The original cable attachment pin 18 may be attached to the shift lever arm 16 by any one of a variety of means, such as welding, screw fastening, riveting or bonding with an adhesive, among other appropriate attachment means. In the depicted exemplary embodiment, the original cable attachment pin 18 is a ball stud which is molded into the shift lever arm 16. In this embodiment, the ball stud includes a shaft that extends from to the shift lever arm 16 and a ball that is attached to the shaft. Preferably, the ball of the ball stud has a larger diameter than the shaft of the ball stud.

In the exemplary embodiment depicted in FIGS. 1 and 2 (exploded in FIG. 1, and assembled in FIG. 2), the short throw assembly 20 is attached to the shift lever assembly 11, such that the short throw assembly 20 is adjacent to the shift lever arm 16. In the depicted exemplary embodiment, the short throw assembly 20 includes a first section 20A and a second section 20B which together define a body 21. The body 21 includes the cable attachment pin 22. The first section 20A includes a first cut-out 46 and a second cut-out 48 and the second section 20B correspondingly comprises a first shoulder 50 and a second shoulder 52, such that when the first and second sections 20A and 20B are connected, the first cut-out 46 and the first shoulder 50 combine to form an opening 51 that closely matches the shape and size of an outer perimeter of the shift lever 12 and the second cut-out 48 and the second shoulder 52 combine to form an opening 53 that closely matches the shape and size of an outer perimeter of the shaft portion of the original cable attachment pin 18. Preferably, the opening 53 formed by the second cut-out 48 and the second shoulder 52 is larger than the neck portion of the original cable attachment pin 18, yet smaller than the head portion of the original cable attachment pin 18. In such an instance, when the first and second sections 20A and 20B are securely connected (as described in more detail below) the openings 51 and 53 in the short throw assembly 20 straddle and/or clamp around the shift lever 12 and the original cable attachment pin 18, respectively, such that the shift lever 12 and the original cable attachment pin 18 securely lock the short throw assembly 20 in position against both lateral and vertical movement. As can be seen, the exemplary embodiment of the short throw assembly 20 can be easily installed or retrofitted to the existing shift lever assembly 11.

The cable attachment pin 22 may be attached to the first section 20A by any of the attachment means described above with respect to the attachment of the original cable attachment pin 18 to the shift lever arm 16. Moreover, the cable attachment pin 22 may be integrally formed with the first section 20A. In the exemplary embodiment shown in FIGS. 1 and 2, the cable attachment pin 22 is threadably attached on a raised portion 58 formed on first section 20A. The cable 30 is attached at one end to the cable attachment pin 22 and at an opposite end to the gear shift mechanism 32, such that movement of the cable by the appropriate distance causes the automobile transmission to shift from one gear to another gear.

In an exemplary embodiment, the cable attachment pin 22 is a ball stud having a ball or head 38 that is attached to a shaft 40. Preferably, the ball 38 of the ball stud has a larger diameter than the diameter of the shaft 40 of the ball stud. The ball stud may also contain a collar 44 disposed on the shaft 40 and spaced a short distance from the ball 38. The collar 44 may act as a stop in embodiments where the shaft 40 of the ball stud includes external threads that threadably engage an internally threaded opening 42 of the short throw assembly 20. In addition, the cable 30 may be attached to the cable attachment pin 22 in the spacing between the head portion 38 and the collar 44, such that the cable 30 is locked in position between the head portion 38 and the collar 44.

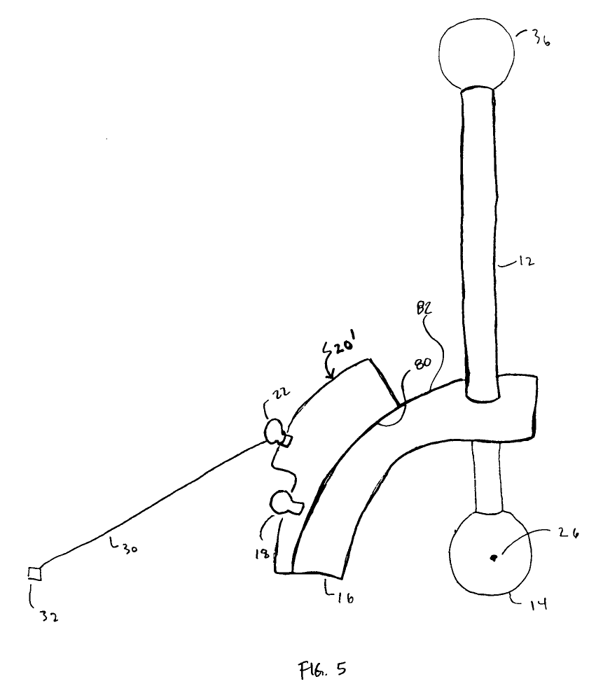

FIG. 5 shows an exemplary alternative embodiment wherein the short throw assembly 20′ extends along only a portion of the shift lever arm 16. For instance, the short throw assembly 20′ may include the first section 20A having the second cut-out 48 and the second section 20B having the second shoulder 52, such that when the first and second sections 20A and 20B are securely connected, the second cut-out 48 and the second shoulder 52 combine to form the opening 53 that closely matches the shape and size of an outer perimeter of the shaft portion of the original cable attachment pin 18 as described above and shown in FIGS. 1 and 2. In such an instance, when the first and second sections 20A and 20B are securely connected, the opening 53 in the short throw assembly 20′ straddles and/or clamps around the original cable attachment pin 18, to securely lock the short throw assembly 20′ in position against both lateral and vertical movement. In yet a further alternate exemplary embodiment, the body 21 may be clamped at only the shift lever 12.

FIG. 6 shows an exemplary alternative embodiment wherein the cable attachment pin 22 is positioned directly in line along a straight line 60 from the shift lever fulcrum 26 to the original cable attachment pin 18, rather being positioned in the above described off-set position. In an embodiment such as that shown in FIG. 6, the body 21 of the short throw assembly 20″ comprises a cavity 62 that surrounds the original cable attachment pin 18 when the short throw assembly 20″ is attached to the shift lever assembly 11.

The first and second sections 20A and 20B may be connected to each other to form the body 21, and also connected to the shift lever 12 and/or the original cable attachment pin 18, by any suitable attachment means to, such as welding, screw fastening, riveting, bonding with an adhesive, or any combination thereof among other appropriate attachment means. In an exemplary embodiment, at least one fastener 54 extends through an opening 55 in the second section 20B and into an opening 56 in the first section 20A to secure the first section 20A to the second section 20B. For example, the first and second sections 20A and 20B may be secured to each other by use of a plurality of fasteners 54, such as by four fasteners 54 as is shown in FIG. 1.

In the depicted exemplary embodiment, the first and second sections 20A and 20B are separate component parts. However, in other embodiments the first and second sections 20A and 20B may be integrally connected, for example through an external hinge or through an internal hinge, among other appropriate connections.

The short throw assembly 20′ may be formed from or include any one of a variety of materials, such as a plastic polymer, a thermoform material, a thermoplastic material or a metal material, among other materials. In addition, the short throw assembly 20′ may be formed by any one of a variety of processes, such as machining, casting, injection molding or stamping, among other fabrication processes.

As discussed, the cable attachment pin 22 of the short throw assembly 20 is positioned such that the distance 24 from the shift lever fulcrum 26 to the cable attachment pin 22 is greater than the distance 28 from the shift lever fulcrum 26 to the original cable attachment pin 18. This increase in distance may be controlled by changing the thickness of the first section 20A and/or by changing the height of the raised section 58.

In one exemplary embodiment, the distance 24 from the shift lever fulcrum 26 to the cable attachment pin 22 is in a range of approximately 0.1 inch to approximately 1.0 inch greater than the distance 28 from the shift lever fulcrum 26 to the original cable attachment pin 18. In another embodiment, the distance 24 from the shift lever fulcrum 26 to the cable attachment pin 22 is in a range of approximately 0.5 inch to 1.0 inch greater than the distance 28 from the shift lever fulcrum 26 to the original cable attachment pin 18. In such an embodiment, the shift lever throw 34 can be reduced by as much as approximately 25%.

Although the difference in the distance 24 from the cable attachment pin 22 to the shift lever fulcrum 26 and the distance 28 from the original cable attachment pin 18 to the shift lever fulcrum 26 may be made greater than that described above, at disparities greater than approximately 1 inch, the movement of the cable 30 between the cable attachment pin 22 and the gear shift mechanism 32 is at an angle that causes the cable to bind up, possibly resulting in a fracture of the cable 30.

In the depicted exemplary embodiment of FIGS. 1 and 2, the cable attachment pin 22 is off-set from a straight line from the shift lever fulcrum 26 to the original cable attachment pin 18. In some instances, various automotive components surrounding the shift lever assembly 11 may require an off-set positioning of the cable attachment pin 22 in order for the cable attachment pin 22 to fit within the areas not occupied by the various components that surround the shift lever assembly 11.

With any of the aforementioned exemplary embodiments, the short throw assembly 20,20′,20″ may be additionally or alternatively secured to the shift lever arm 16, and/or to the original cable attachment pin 18, and/or the shift lever 12 by the use of fasteners, adhesives, or welds.

With any of the aforementioned exemplary embodiments, the short throw assembly 20,20′,20″ may include an inner surface 80 that is complementary to an outer surface 82 of the shift lever arm 16. For example, in the exemplary embodiments depicted in FIGS. 1-3, 5 and 6, the outer surface 82 of the shift lever arm 16 is curved and the inner surface 80 of the short throw assembly 20,20′,20″ has a similar curvature to mate with the curvature of the outer surface 82 of the shift lever arm 16. As such, when the short throw assembly 20,20′,20″ is coupled to the shift lever assembly 11, the short throw assembly 20,20′,20″ fits snugly against the shift lever arm 16 and therefore minimizes the space occupied by the short throw assembly 20,20′,20″. For example, in one embodiment, the inner surface 80 of the short throw assembly 20,20′,20″ is curved to substantially mimic and mate with the curvature of the outer surface of the shift lever arm of a Honda Civic, such as a 2002 Honda Civic.

The preceding description has been presented with references to presently preferred embodiments of the invention. Persons skilled in the art and technology to which this invention pertains will appreciate that alterations and changes in the described structures and methods of operation can be practiced without meaningfully departing from the principle, spirit and scope of this invention. Accordingly, the foregoing description should not be read as pertaining only to the precise structures described and shown in the accompanying drawings.

1. A shift lever assembly comprising:
a shift lever having a fulcrum;
a shift lever arm coupled to the shift lever, the shift lever arm having a first cable attachment site disposed at a first radial distance from the fulcrum;
a short throw assembly attached to one of the shift lever and the shift lever arm, the short throw assembly having a second cable attachment site disposed at a second radial distance from the fulcrum, wherein the second radial distance is greater than the first radial distance, and wherein the short throw assembly has an inner surface that is complementary with an outer surface of the shift lever arm.

2. The shift lever assembly of claim 1, wherein short throw assembly locks against the shift lever.

3. The shift lever assembly of claim 1, wherein short throw assembly locks against the first cable attachment site.

4. The shift lever assembly of claim 1, wherein short throw assembly locks against both the shift lever and the first cable attachment site.

5. The shift lever assembly of claim 1, wherein the short throw assembly comprises a first portion and a second portion, wherein the first portion is secured to the second portion by at least one fastener.

6. The shift lever assembly of claim 5, wherein the first and second portions combine to form a first opening that receives the shift lever.

7. The shift lever assembly of claim 5, wherein the first and second portions combine to form a second opening that receives the first cable attachment site.

8. The shift lever assembly of claim 5, wherein the first and second portions combine to form a first opening that receives the shift lever and a second opening that receives the first cable attachment site.

9. The shift lever assembly of claim 1, wherein the second radial distance is in the range of approximately 0.1 inch to approximately 1.0 inch greater than the first radial distance.

10. The shift lever assembly of claim 1, wherein the second radial distance is in the range of approximately 0.5 inch to approximately 1.0 inch greater than the first radial distance.

11. The shift lever assembly of claim 1, wherein the second cable attachment site is a ball stud.

12. The shift lever assembly of claim 11, wherein the ball stud comprises a ball and a shaft, and wherein the ball has a larger diameter than the shaft.

13. The shift lever assembly of claim 12, wherein the ball stud further comprises a shoulder attached to the shaft and spaced apart from the ball to allow a cable to be attached between the ball and the shoulder.

14. The shift lever assembly of claim 13, wherein the shaft of the ball stud includes threads that threadably engage threads in the short throw assembly.

15. The shift lever assembly of claim 1, further comprising a ball joint attached to the shift lever, wherein the fulcrum of the shift lever is disposed in the ball joint.

16. A shift lever assembly comprising:
a shift lever having a fulcrum;
a shift lever arm attached to the shift lever, the shift lever arm having a first cable attachment site disposed at a first radial distance from the fulcrum;
a short throw assembly coupled to one of the shift lever and the shift lever arm, the short throw assembly having a second cable attachment site disposed at a second radial distance from the fulcrum, wherein the second radial distance is greater than the first radial distance, and wherein the short throw assembly straddles one of the shift lever and the first cable attachment site.

17. The shift lever assembly of claim 16, wherein the short throw assembly comprises clamping means for engaging one of the shift lever and the first cable attachment.

18. The shift lever assembly of claim 16, wherein the short throw assembly comprises a first portion and a second portion, wherein the first portion is secured to the second portion by at least one fastener, such that the first and second portions straddle one of the shift lever and the first cable attachment site therebetween.

19. The shift lever assembly of claim 18, wherein the first and second portions combine to form a first opening that receives the shift lever.

20. The shift lever assembly of claim 18, wherein the first and second portions combine to form a second opening that receives the first cable attachment site.

21. The shift lever assembly of claim 18, wherein the first and second portions combine to form a first opening that receives the shift lever and a second opening that receives the first cable attachment site.

22. The shift lever assembly of claim 16, wherein the short throw assembly has an inner surface that is complementary with an outer surface of the shift lever arm.

23. A short throw assembly for reducing the throw on a 2002 Honda Civic shift lever assembly, wherein the 2002 Honda Civic shift lever assembly comprises a shift lever having a fulcrum and a shift lever arm attached to the shift lever, wherein the shift lever arm has a first cable attachment site disposed at a first radial distance from the fulcrum, the short throw assembly comprising:
a second cable attachment site disposed at a second radial distance from the fulcrum, wherein the second radial distance is greater than the first radial distance and wherein the short throw assembly has an inner surface that is complementary with an outer surface of the shift lever arm.

24. A short throw assembly for reducing the throw on a 2002 Honda Civic shift lever assembly, wherein the 2002 Honda Civic shift lever assembly comprises a shift lever having a fulcrum and a shift lever arm attached to the shift lever, wherein the shift lever arm has a first cable attachment site disposed at a first radial distance from the fulcrum, the short throw assembly comprising:
a second cable attachment site disposed at a second radial distance from the fulcrum, wherein the second radial distance is greater than the first radial distance and wherein the short throw assembly straddles one of the shift lever and the first cable attachment site.

25. The shift lever assembly of claim 24, wherein the short throw assembly comprises clamping means for engaging one of the shift lever and the first cable attachment.

26. The shift lever assembly of claim 24, wherein the short throw assembly comprises a first portion and a second portion, wherein the first portion is secured to the second portion by at least one fastener, such that the first and second portions straddle one of the shift lever and the first cable attachment site therebetween.

27. The shift lever assembly of claim 26, wherein the first and second portions combine to form a first opening that receives the shift lever.

28. The shift lever assembly of claim 26, wherein the first and second portions combine to form a second opening that receives the first cable attachment site.

29. The shift lever assembly of claim 26, wherein the first and second portions combine to form a first opening that receives the shift lever and a second opening that receives the first cable attachment site.

30. The shift lever assembly of claim 24, wherein the short throw assembly has an inner surface that is complementary with an outer surface of the shift lever arm.
